(19) United States
(12) Patent Application Publication
(10) Pub. No.: US 2016/0272515 A1
(43) Pub. Date: Sep. 22, 2016

(54) COMPOSITION FOR ELECTRODE OF CAPACITIVE DEIONIZATION APPARATUS AND ELECTRODE INCLUDING SAME

(71) Applicant: SAMSUNG ELECTRONICS CO., LTD, Suwon-si, Gyeonggi-do (KR)

(72) Inventors: Yeong Suk CHOI, Suwon-si (KR); Seung Jae LEE, Suwon-si (KR); Joon Seon JEONG, Seoul (KR)

(73) Assignee: Samsung Electronics Co., Ltd., Suwon-si, Gyeonggi-do (KR)

(21) Appl. No.: 15/034,026

(22) PCT Filed: Nov. 20, 2014
(86) PCT No.: PCT/KR2014/011202

§ 371 Date: May 3, 2016

(30) Foreign Application Priority Data
Nov. 20, 2013 (KR) 10-2013--0141511

(51) Int. Cl. C02F 1/469; C08L 29/04; C02F 1/46

(52) U.S. Cl. CPC C02F 1/4691; C02F 1/4604; C02F 1/4602; C08L 29/04; C02F 2101/10

(57) ABSTRACT

A binder composition for an electrode of a capacitive deionization apparatus includes a hydrophilic polymer, a cross-linking agent, an ion exchange group, and a latex in a form of an emulsion polymer having an ionic functional group on the surface.

### CROSS REFERENCE TO RELATED APPLICATIONS

This is a National Phase Application of PCT/KR2014/011202, filed Nov. 20, 2014, which is an International Application claiming priority to Korean Application No. 10-2013-0141511, filed Nov. 20, 2013, the entire contents of each of which are herein incorporated by reference.

### TECHNICAL FIELD

Example embodiments are directed to an electrode composition for a capacitive deionization apparatus and an electrode for a capacitive deionization apparatus including the same.

### BACKGROUND ART

In some regions, domestic water may include a large amount of minerals. In Europe and other regions, limestone substances frequently flow in underground water, and thus tap water in these regions contains a large amount of minerals. Water having a high mineral content (i.e., hard water) may cause problems of easy occurrence of lime scales in the interior walls of pipes and a sharp decrease in energy efficiency when it is used for home installations, for example, in a heat exchanger or a boiler. In addition, hard water is inappropriate for use as wash water. Therefore, there has been a demand for technology for removing ions from hard water to make it into soft water, in particular, in an environmentally-friendly manner. Further, demands for seawater desalination have increased as larger areas are suffering from water shortages.

A capacitive deionization (CDI) apparatus is a device for applying a voltage to porous electrodes having nano-sized pores to make them carry a polarity and thereby adsorb ionic materials from a medium such as hard water onto the surface of the electrodes, and thus remove the same therefrom. In the CDI apparatus, when a medium containing dissolved ions flows between two electrodes of an anode and a cathode and DC power having a low potential difference is applied thereto, the anionic components and the cationic components among the dissolved ions are adsorbed and concentrated onto the anode and the cathode, respectively. When an electric current flows in a reverse direction between the two electrodes by, for example, short-circuiting the two electrodes, the concentrated ions are desorbed from the electrodes. Since the CDI apparatus does not require a high potential difference, its energy efficiency is high, harmful ions may be removed together with the hard components when the ions are adsorbed, and its recycling process does not need any chemicals.

### SUMMARY

One embodiment provides an electrode composition for a capacitive deionization apparatus.

Another embodiment provides an electrode for a capacitive deionization apparatus including the composition.

Yet another embodiment provides a capacitive deionization apparatus including the electrode for a capacitive deionization apparatus.

One embodiment provides a binder composition for an electrode of a capacitive deionization apparatus including a hydrophilic polymer, a cross-linking agent, an ion exchange group, and a latex in a form of an emulsion polymerization product having an ionic functional group on the surface.

The hydrophilic polymer may be at least one selected from polystyrene, polyacrylic acid, polyacrylic acid-co-maleic acid, polyvinyl alcohol, carboxymethyl cellulose, hydroxypropyl cellulose, polyvinylchloride, carboxylated polyvinylchloride, polyvinylfluoride, polyvinylamine, chitosan, polyamide, polyurethane, polyacrylamide, polyacrylamide-co-acrylic acid, polystyrene-co-acrylic acid, polytetrafluoroethylene, polyvinylidene fluoride, polyethylene, polypropylene, polyvinylpyrrolidone, an epoxy resin, and a combination thereof.

The cross-linking agent may be at least one selected from ethylene glycol, glycerol, 1,6-hexanediol, 1.4-butanediol, glutaric acid, glutaric aldehyde, succinic acid, succinic anhydride, adipic acid, phthalic acid, ethylene glycol diglycidyl ether, sulfosuccinic acid, sulfosalicylic acid, succinamic acid, ethylenediamine, and a combination thereof.

The ion exchange group may be at least one selected from sulfoacetic acid, sulfophthalic acid, sulfosalicylic acid, hydroquinonesulfonic acid, sulfobenzoic acid, tetrabutylammonium hydroxide, tetrabutylammonium acetate, tetraethylammonium hydroxide, tetraethylammonium acetate, and a combination thereof.

The latex may be at least one selected from a latex of a butadiene-based hybrid polymer, a latex of a diene-based hybrid polymer, a latex of acrylate-based hybrid polymer, a latex of a nitrile rubber, a latex of a chloroprene rubber, a polyurethane-based latex, or a combination thereof, and may have an ionic functional group such as a cation exchange group, an anion exchange group, or a hydrophilic group on the surface.

The cation exchange group bound on the surface of the latex may be a carboxyl group, a sulfonic acid group, a hydroxy group, a phosphinic group, an arsonic group, a selenonic group, or a combination thereof, and the anion exchange group may be an amine group such as a primary amine (—NH2), a secondary amine (—NHR), and a tertiary amine (—NR2), a quaternary ammonium salt (—NR3), a quaternary phosphonium group (—PR4), a tertiary sulfonium group (—SR3), or a combination thereof, and the hydrophilic group may include an epoxy compound.

Specific examples of the latex may be at least one selected from an SBR (styrene butadiene rubber) latex, an NBR (nitrile butadiene rubber) latex, a latex of PMMA (polymethylmethacrylate) and a copolymer thereof, a latex of polystyrene and a copolymer thereof, an ethylene vinyl acetate (EVA) latex, an acrylic latex, and a combination thereof.

The ionic functional group may be included in an amount of about 0.5 to about 50 parts by weight based on the total amount of the latex.

The binder composition may include water as a solvent.

The cross-linking agent may be included in a range of about 5 to about 100 parts by weight based on 100 parts by weight of the hydrophilic polymer.

The ion exchange group may be included in an amount of about 10 to about 300 parts by weight based on 100 parts by weight of the hydrophilic polymer.

The latex may be included in an amount of about 10 to about 400 parts by weight based on 100 parts by weight of the hydrophilic polymer.

The hydrophilic polymer may have a weight average molecular weight ranging from about 30,000 to about 10,000,000 g/mol.

The hydrophilic polymer may be dissolved in a range of about 3 to about 15 wt % in the solvent.

Another embodiment provides an electrode composition for a capacitive deionization apparatus including the binder composition and electrode active material.

The electrode active material may be an activated carbon-based material or a metal oxide-based material.

The activated carbon-based material may be an activated carbon powder, an activated carbon fiber, carbon nanotubes, a carbon aerogel, mesoporous carbon, a graphite oxide, or a mixture thereof.

The metal oxide-based material may be RuO2, Ni(OH)2, MnO2, PbO2, TiO2, or a mixture thereof.

The electrode active material may be used in an amount of about 5 to about 400 parts by weight, and for example, about 20 to about 300 parts by weight, based on 100 parts by weight of the hydrophilic polymer in the binder.

The electrode composition may further include a conductive material.

The conductive material may be at least one selected from the group consisting of a carbon-based material selected from VGCF (vapor growth carbon fiber), natural graphite, artificial graphite, acetylene black, ketjen black, XCF (electrically conductive furnace) carbon, SRF (semi-reinforcing furnace black) carbon, and carbon fiber; a metal powder or a metal fiber selected from copper, nickel, aluminum, and silver; a conductive polymer; an inorganic salt of LiCI, NaCl, or KCl; and a mixture thereof.

The conductive material may be included in an amount of about 0.1 to about 35 parts by weight based on the total amount of the electrode active material.

According to another embodiment, an electrode for a capacitive deionization apparatus including the electrode composition for a capacitive deionization apparatus, and a method of manufacturing the electrode, are provided.

The electrode for a capacitive deionization apparatus may be manufactured by coating the electrode composition for a capacitive deionization apparatus on a current collector.

The current collector may be a sheet, a thin film, or a plain weave gold mesh including aluminum, nickel, copper, titanium, iron, stainless steel, graphite, or a mixture thereof.

The electrode composition may be coated on the current collector in a method of dip coating, spray coating, knife casting, doctor blade coating, spin coating, and the like.

Still another embodiment provides a capacitive deionization apparatus including the electrode for a capacitive deionization apparatus as a cathode or an anode, another electrode facing the anode or the cathode, and a spacer disposed between the cathode and the anode.

The spacer may have an open mesh, non-woven fabric, woven fabric, or foam shape.

The deionization apparatus may further a charge barrier disposed between the electrode and the spacer and including a different material from the electrode material.

Another embodiment provides a method of removing ions from a fluid using the capacitive deionization apparatus.

The method of removing ions from a fluid using the capacitive deionization apparatus includes providing a capacitive deionization apparatus including the electrode for a capacitive deionization apparatus according to the embodiment, another electrode facing the electrode, and a spacer disposed between the electrodes; and applying a voltage to the electrodes while supplying an ion-containing fluid into the capacitive deionization apparatus.

The method of treating the fluid may further include desorbing ions adsorbed on the electrodes by short-circuiting the electrodes, or applying a reverse voltage to the electrodes.

The electrode composition for a capacitive deionization apparatus allows the active material of the electrode to cure fast, whereby improves production effectiveness. Further, the composition prevents the surface of electrode from having cracks.

### BRIEF DESCRIPTION OF THE DRAWINGS

FIG. 1 schematically shows a binder in which a hydrophilic polymer, a cross-linking agent, and an ion exchange group are cross-linked with one another, and a latex including an ionic functional group and being in an emulsion polymer state is bound therewith according to an example embodiment.

FIGS. 2(A)-2(C) are schematic views showing examples of a capacitive deionization apparatus.

FIG. 3 is a graph showing the curing heat amount of binder compositions with or without a latex according to examples and a comparative example measured by using differential scanning calorimetry (DSC).

FIG. 4 is an ion conductivity graph showing ion removal performance of an electrode of CDI apparatuses including anodes according to examples and a comparative example that are cured at 120° C. for 5 hours, and

FIG. 5 is an ion conductivity graph showing ion removal performance of an electrode of CDI apparatuses including anodes according to examples and a comparative example that are cured at 130° C. for 40 minutes.

### DETAILED DESCRIPTION

Advantages and characteristics of this disclosure, and a method for achieving the same, will become evident referring to the following example embodiments together with the drawings attached hereto. However, this disclosure may be embodied in many different forms and is not to be construed as limited to the embodiments set forth herein; rather, these embodiments are provided so that this disclosure will satisfy applicable legal requirements. Therefore, in some embodiments, well-known process technologies are not explained in detail in order to avoid vague interpretation of the present disclosure. If not defined otherwise, all terms (including technical and scientific terms) in the specification may be defined as commonly understood by one skilled in the art. The terms defined in a generally-used dictionary may not be interpreted ideally or exaggeratedly unless clearly defined to the contrary. In addition, unless explicitly described to the contrary, the word “comprise” and variations such as “comprises” or “comprising” will be understood to imply the inclusion of stated elements but not the exclusion of any other elements.

Example embodiments may be described referring to example schematic views. Accordingly, the regions shown in the drawing are overviews and do not limit the scope of the disclosure. The same reference numerals designate the same constituent elements throughout the specification.

As used herein, the term “capacitive deionization apparatus” refers to a device that may separate/concentrate ions by passing fluids to be separated or to be concentrated including at least one ion component through a flow path formed between at least one pair of porous electrodes and applying a voltage thereto so as to adsorb the ion components on the pores in the electrodes. The “capacitive deionization apparatus” may have any geometric structure.

One embodiment provides a binder composition for an electrode of a capacitive deionization apparatus including a hydrophilic polymer, a cross-linking agent, an ion exchange group, and a latex in a form of an emulsion polymerization product having an ionic functional group on the surface.

The binder is mixed with an electrode active material, and increases a bonding force in the electrode active material itself and/or between the electrode active material and a current collector during manufacture of an electrode for a capacitive deionization apparatus.

The electrode may be a cathode or an anode, and kinds of ion exchange group in the binder and ionic functional group on the surface of the latex may be appropriately selected depending on the cathode or the anode.

The hydrophilic polymer may be at least one selected from polystyrene, polyacrylic acid, polyacrylic acid-co-maleic acid, polyvinyl alcohol, carboxylmethyl cellulose, hydroxypropyl cellulose, polyvinylchloride, carboxylated polyvinylchloride, polyvinylfluoride, polyvinylamine, chitosan, polyamide, polyurethane, polyacrylamide, polyacrylamide-co-acrylic acid, polystyrene-co-acrylic acid, polytetrafluoroethylene, polyvinylidene fluoride, polyethylene, polypropylene, polyvinylpyrrolidone, an epoxy resin, and a combination thereof, but is not limited thereto.

The cross-linking agent may be at least one selected from ethylene glycol, glycerol, 1,6-hexanediol, 1.4-butanediol, glutaric acid, glutaric aldehyde, succinic acid, succinic anhydride, adipic acid, phthalic acid, ethylene glycol diglycidyl ether, sulfosuccineic acid, sulfosalicylic acid, succinamic acid, ethylenediamine, and a combination thereof, but is not limited thereto.

The ion exchange group may be at least one selected from sulfoacetic acid, sulfophthalic acid, sulfosalicylic acid, hydroquinonesulfonic acid, sulfobenzoic acid, tetrabutylammonium hydroxide, tetrabutylammonium acetate, tetraethylammonium hydroxide, tetraethylammonium acetate, and a combination thereof, but is not limited thereto.

The latex may be at least one selected from a latex of a butadiene-based hybrid polymer, a latex of a diene-based hybrid polymer, a latex of an acrylate-based hybrid polymer, a latex of nitrile rubber, a latex of a chloroprene rubber, a polyurethane-based latex, or a combination thereof. For example, at least one selected from a SBR (styrene butadiene rubber) latex, an NBR (nitrile butadiene rubber) latex, a latex of PMMA (polymethylmethacrylate) and a copolymer thereof, a latex of polystyrene and a copolymer thereof, an ethylene vinyl acetate (EVA) latex, and an acrylic latex, and having a bond with a cation exchange group, an anion exchange group, or a hydrophilic group, may be used.

The cation exchange group on the surface of the latex may be, for example, a carboxyl group, a sulfonic acid group, a hydroxy group, a phosphinic group, an arsonic group, a selenonic group, or a combination thereof, and the anion exchange group on the surface of the latex may be an amine group such as a primary amine (—NH2), a secondary amine (—NHR), and a tertiary amine (—NR2), a quaternary ammonium salt (—NR3), a quaternary phosphonium group (—PR4), a tertiary sulfonium group (—SR3), and the like, or the hydrophilic group may include an epoxy group.

The binder according to the embodiment includes the hydrophilic polymer, a cross-linking agent, an ion exchange group, and a latex having an ionic functional group on the surface, and may shorten a time of curing an electrode active material during manufacture of an electrode.

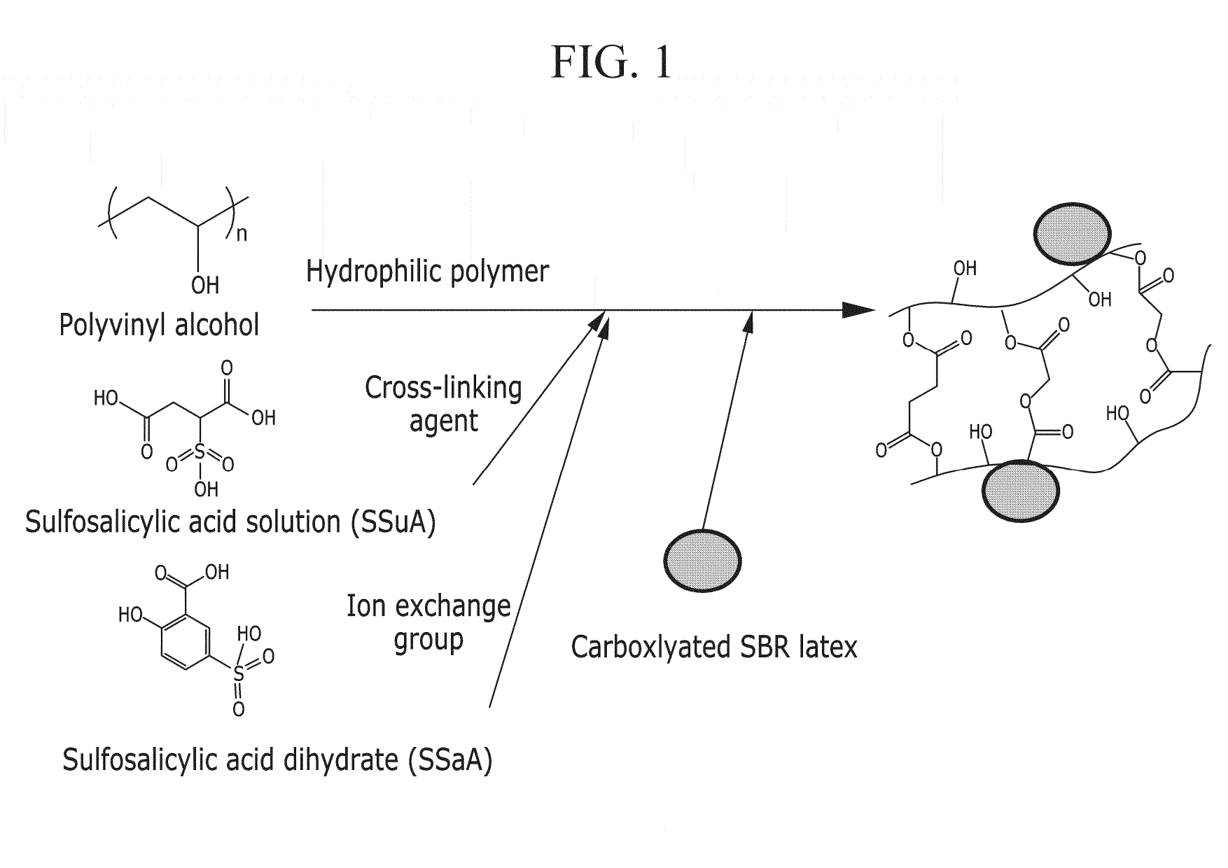

FIG. 1 schematically shows a bonding relationship among a hydrophilic polymer, a cross-linking agent, an ion exchange group, and a latex having an ionic functional group on the surface in the binder according to an example embodiment. As shown in the drawing, a binder including polyvinyl alcohol as the hydrophilic polymer, sulfosuccinic acid as the cross-linking agent, sulfosalicylic acid dihydrate as the ion exchange group, and a carboxylated SBR latex shows a network structure of the hydrophilic polymer cross-linked by the cross-linking agent and the ion exchange group bound with the cross-linked hydrophilic polymer through its functional group and stably included in the binder. Herein, the SBR latex including an ionic functional group such as a carboxyl group and the like is bound with the hydrophilic polymer due to dipolar interaction and the like through the ionic functional group, for example, a carboxyl group on the surface, which shows that a latex may be bound with a hydrophilic polymer well. Herein, acidity or alkalinity of the ionic functional group such as a carboxyl group and the like bound on the surface of the latex may play a role of a catalyst for cross-linking of a water-soluble polymer due to the cross-linking agent, decrease energy for the cross-linking of the water-soluble polymer, and resultantly, increase close-contacting force of a binder composition including the latex.

When this binder composition is mixed with an electrode active material to prepare an electrode slurry, the binder is more bound with the electrode active material due to a close-contacting force increased by the latex, and thus, a close-contacting force between the electrode active material and a current collector is also increased.

In this way, when an electrode is manufactured by using the electrode active material and the binder having an increased close-contacting force, the electrode active material may be cured in a shorter time or at a lower temperature, and less energy is required to manufacture the electrode for a capacitive deionization apparatus.

In the binder, the cross-linking agent may be used in an amount of about 5 to about 100 parts by weight, for example, about 10 to about 90 parts by weight, and for another example, about 20 to about 80 parts by weight based on 100 parts by weight of the hydrophilic polymer, and the ion exchange group may be included in an amount of about 10 to about 300 parts by weight, for example, about 50 to about 280 parts by weight, and for another example, about 100 to about 250 parts by weight based on 100 parts by weight of the hydrophilic polymer.

When the cross-linking agent and the ion exchange group are included within the range, the hydrophilic polymer may be appropriately cross-linked in the binder, and the ion exchange group is bound with the hydrophilic polymer in an appropriate ratio and thus may increase ion removal efficiency of a capacitive deionization apparatus.

In addition, the latex may be included in an amount of about 10 to about 400 parts by weight, for example, about 15 to about 300 parts by weight, and for another example, about 25 to about 250 parts by weight based on 100 parts by weight of the hydrophilic polymer. When the latex is included within the range, the electrode active material is cured in a shorter time, and ion removal efficiency may be further improved.

On the other hand, the ionic functional group on the surface of the latex may be included in an amount of about 0.5 to about 50 parts by weight, for example, about 1 to about 45 parts by weight, and for another example, about 2 to about 40 parts by weight based on the total amount of the latex. When the ionic functional group is included in an amount of greater than about 50 parts by weight, an electrode is hard to manufacture due to largely increased viscosity of the slurry, while when the ionic functional group is included in an amount of less than about 0.5 parts by weight, a close-contacting force of a binder is not increased by much.

The binder composition may further include water as a solvent. In other words, the binder composition includes a hydrophilic polymer as a main component, and a hydrophilic solvent such as water, and resultantly may be environmentally friendly.

The hydrophilic polymer may have a weight average molecular weight ranging from about 30,000 to about 10,000,000 g/mol, and may be dissolved in a range of about 3 to about 15 wt % in a solvent.

When the hydrophilic polymer has a weight average molecular weight within the range and is dissolved in a solvent within the concentration range, an appropriate viscosity is obtained during manufacture of a binder or electrode slurry by mixing the binder with an electrode active material, and excellent bonding characteristics of the electrode active material are also obtained.

Another embodiment provides an electrode composition for a capacitive deionization apparatus including the binder composition and an electrode active material.

The electrode active material may be an activated carbon-based material when the electrode is a cathode, while the electrode active material may be a metal oxide-based material when the electrode is an anode.

The activated carbon-based material may be an activated carbon powder, an activated carbon fiber, carbon nanotubes, a carbon aerogel, mesoporous carbon, graphite oxide, or a mixture thereof.

The metal oxide-based material may be RuO2, Ni(OH)2, MnO2, PbO2, TiO2, or a mixture thereof.

The electrode active material may be included in an amount of about 5 to about 400 parts by weight, for example, about 20 to about 300 parts by weight, and for another example, about 30 to about 250 parts by weight based on 100 parts by weight of the hydrophilic polymer in the binder. When the electrode active material and the hydrophilic polymer are included within the ratio range in an electrode composition, appropriate viscosity of the electrode slurry and excellent bonding characteristics of the electrode active material may be obtained.

The electrode composition may further include a conductive material.

The conductive material may be at least one selected from a carbon-based material selected from VGCF (vapor growth carbon fiber), natural graphite, artificial graphite, acetylene black, ketjen black, XCF (electrically conductive furnace) carbon, SRF (semi-reinforcing furnace black) carbon, and a carbon fiber; a metal powder or a metal fiber selected from copper, nickel, aluminum, and silver; a conductive polymer; an inorganic salt of LiCI, NaCl, or KCl; and a mixture thereof.

The conductive material may be included in an amount of about 0.1 to about 35 parts by weight, and for example, about 1 part by weight to about 30 parts by weight based on 100 parts by weight of the electrode active material. When the conductive material is included in an amount of less than about 0.1 parts by weight, an electrode may lack conductivity, while when the conductive material is included in an amount of greater than about 35 parts by weight, an electrode may not be economically manufactured and may also have less porosity.

When the binder further includes a solvent such as water and the like, the electrode composition may be prepared into an electrode slurry and coated on a current collector, manufacturing an electrode.

Accordingly, still another embodiment provides an electrode for a capacitive deionization apparatus including the electrode composition and a method of manufacturing the electrode.

The electrode may be an anode or a cathode, and when the electrode is an anode, the electrode may have an anion exchange group, while the electrode is a cathode, the electrode may have a cation exchange group.

The electrode for a capacitive deionization apparatus may be manufactured by coating the electrode composition for a capacitive deionization apparatus on a current collector.

The current collector may be a sheet, a thin film, or a plain weave gold mesh including aluminum, nickel, copper, titanium, iron, stainless steel, graphite, or a mixture thereof.

The coating of the electrode composition on the current collector may be performed in a method of dip coating, spray coating, knife casting, doctor blade coating, spin coating, and the like.

The thickness of the electrode may not be particularly limited, and may be selected within an appropriate range. For example, the thickness of the electrode may be about 50 μm to about 500 μm, and specifically about 100 μm to about 350 μm.

The electrode may be manufactured by additionally coating an ion exchange polymer on a surface of the electrode material coated on the current collector.

The ion exchange polymer may be a polymer including a cation exchange group selected from a sulfonic acid group (—SO3H), a carboxyl group (—COOH), a phosphonic group (—PO3H2), a phosphinic group (—HPO3H), an arsonic group (—AsO3H2), and a selenonic acid group (—SeO3H) at a main chain or a side chain of the above generally-used binder polymer, or a polymer including an anion exchange group selected from a quaternary ammonium salt (—NR3), primary to tertiary amine groups (—NH2, —NHR, or —NR2), a quaternary phosphonium group (—PR4), and a tertiary sulfonium group (—SR3) at a main chain or a side chain of the polymer. Such a polymer may be synthesized using an appropriate method, or may be a commercially available product.

In addition, yet another embodiment provides a capacitive deionization apparatus including the electrode of a cathode or an anode, another electrode facing the anode or the cathode, and a spacer disposed between the cathode and the anode.

The capacitive deionization apparatus may further include a charge barrier disposed between the electrode and the spacer and made of a different material from the electrode material.

The spacer disposed between the pair of electrodes may form a path (i.e., a flow path) for flowing a fluid between the electrodes, and includes an electrically insulating material and thus prevents a short-circuit between the electrodes.

The spacer may be formed of any material for forming a flow path and preventing an electrode short-circuit, and may have any structure. As a non-limiting example, the spacer may have an open mesh, non-woven fabric, woven fabric, or foam shape. As a non-limiting example, the spacer may include polyesters such as polyethylene terephthalate and the like; polyolefins such as polypropylene, polyethylene, and the like; polyamides such as nylon and the like; an aromatic vinyl-based polymer such as polystyrene; a cellulose derivative such as cellulose, methyl cellulose, acetylmethyl cellulose, and the like; a polyetherether ketone; a polyimide; polyvinyl chloride; or a combination thereof. The thickness of the spacer is not particularly limited, but it may range from about 50 μm to about 500 μm, for example about 100 μm to about 350 μm, in light of the flow amount and the solution resistance. The open area of the spacer may range from about 20% to about 80%, for example about 30% to about 50%, in light of the flow amount and the solution resistance.

The capacitive deionization apparatus may further include a charge barrier disposed between the spacer and the electrode. The charge barrier may be a cation permselective membrane or an anion permselective membrane. The cation or anion permselective membrane may be prepared by an appropriate method, or is commercially available. Examples of cation or anion permselective membranes which may be used in the capacitive deionization apparatus may include, but are not limited to, Neosepta CMX, Neosepta AMX, or the like manufactured by Tokuyama.

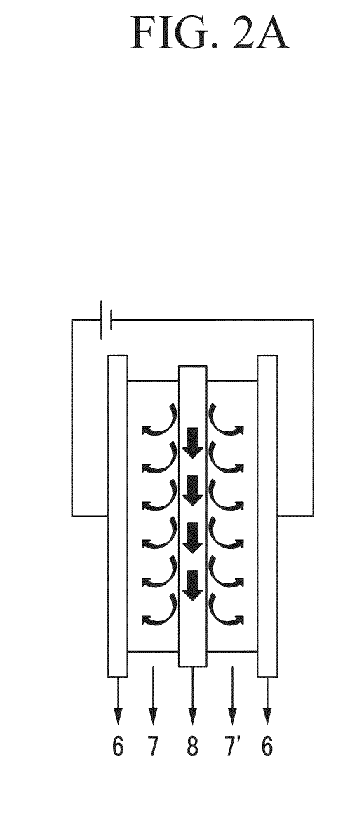

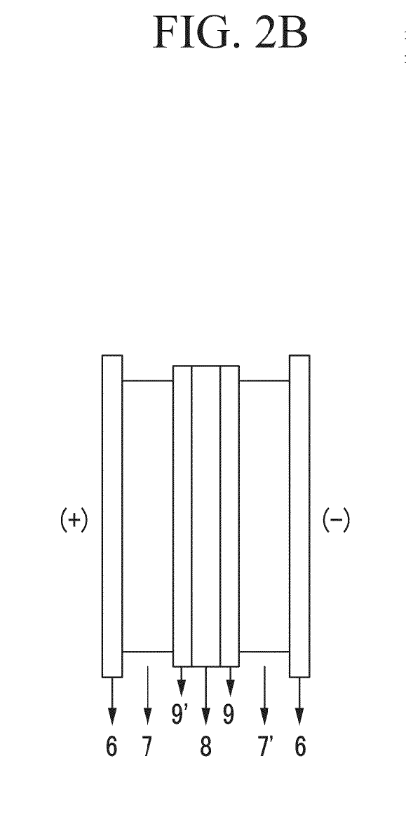

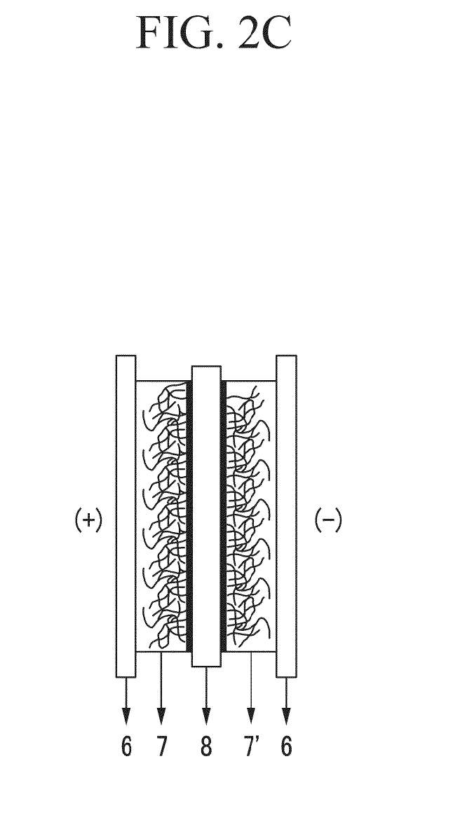

The capacitive deionization apparatus may have any geometric structure. By way of non-limiting examples, the capacitive deionization apparatus may have a schematic structure as shown in FIG. 2 (A) to (C). Hereinafter, the capacitive deionization apparatus will be explained with reference to the drawings.

Referring to FIG. 2 (A), electrodes 7 and 7′ are respectively coated on current collectors 6, and a spacer 8 is interposed between the electrodes 7 and 7′ to provide a flow path. In the capacitive deionization apparatus shown in FIG. 2 (B), the electrodes 7 and 7′ are respectively coated on current collectors 6, a spacer 8 is inserted between the electrodes 7 and 7′ to provide a flow path, and a cation permselective membrane 9′ and an anion permselective membrane 9 are interposed between the electrodes 7 and 7′ and the spacer 8. In addition, in the case of apparatus shown in FIG. 2 (C), electrodes 7 and 7′ are respectively coated on current collectors 6, and a spacer 8 is interposed between the electrodes 7 and 7′ to define a flow path, wherein the electrode 7 is an anode using an anion exchange binder, and the electrode 7′ is a cathode using a cation exchange binder.

Another embodiment provides a method of removing ions from a fluid using the capacitive deionization apparatus.

Specifically, the method includes treating the fluid by providing a capacitive deionization apparatus including an electrode for a capacitive deionization apparatus, another electrode facing the electrode, and a spacer disposed between the electrodes according to the embodiment, and applying a voltage to the electrodes while supplying an ion-containing fluid into the capacitive deionization apparatus.

The method of treating the fluid may further include desorbing ions adsorbed in the electrodes by short-circuiting the electrodes or applying a reverse voltage to the electrodes in a reverse direction.

The details of the capacitive deionization apparatus are the same as described above.

The ion-containing fluid, supplied into the capacitive deionization apparatus, is not particularly limited, but for example, it may be sea water, or it may be hard water containing calcium ions or magnesium ions. The rate of supplying the fluid is not particularly limited, but may be adjusted as required. For example, the rate may range from about 5 to about 50 ml/minute.

When a DC voltage is applied to the electrode while supplying the fluid, the ions present in the fluid are adsorbed onto the surface of the electrode. The applied voltage may be appropriately selected in light of the cell resistance, the concentration of the solution, or the like, and for example, it may be about 2.5 V or lower, and specifically, may range from about 1.0 V to about 2.0 V. When applying the voltage, the ion removal efficiency, as calculated from the measurement of the ion conductivity of the fluid, may be about 50% or higher, specifically, about 75% or higher, and more specifically, about 90% or higher.

The aforementioned capacitive deionization apparatus and the aforementioned methods may find utility in most home appliances using water, for example, a washing machine, a refrigerator, a water softener, or the like, and may also be used in an industrial water treatment device such as for seawater desalination and ultrapure water manufacture.

Hereinafter, the embodiments are illustrated in more detail with reference to examples. However, it is understood that the scope of the present disclosure is not limited to these examples.

### Examples 1 to 5 and Comparative Example 1

### Preparation of Binder and Measurement of Curing Heat

A polymer solution is prepared by adding 0.7 g of sulfosuccinic acid as a cross-linking agent and 2.8 g of sulfosalicylic acid as an ion exchange aid to 12.6 g of a PVA 10% aqueous solution and agitating the mixture. Each binder according to Examples 1 to 5 is prepared by respectively adding a 5% carboxylated SBR latex in each amount of 0.4 g (Example 1), 0.8 g (Example 2), 1.0 g (Example 3), 3.0 g (Example 4), and 6.0 g (Example 5) to the polymer solution and agitating the mixtures with a Thinky mixer for 5 minutes. On the other hand, the polymer solution not including the latex is used as a binder according to Comparative Example 1. When a solution has too high a viscosity during preparation of the binder, an appropriate amount of water is additionally added thereto, and the mixture is agitated.

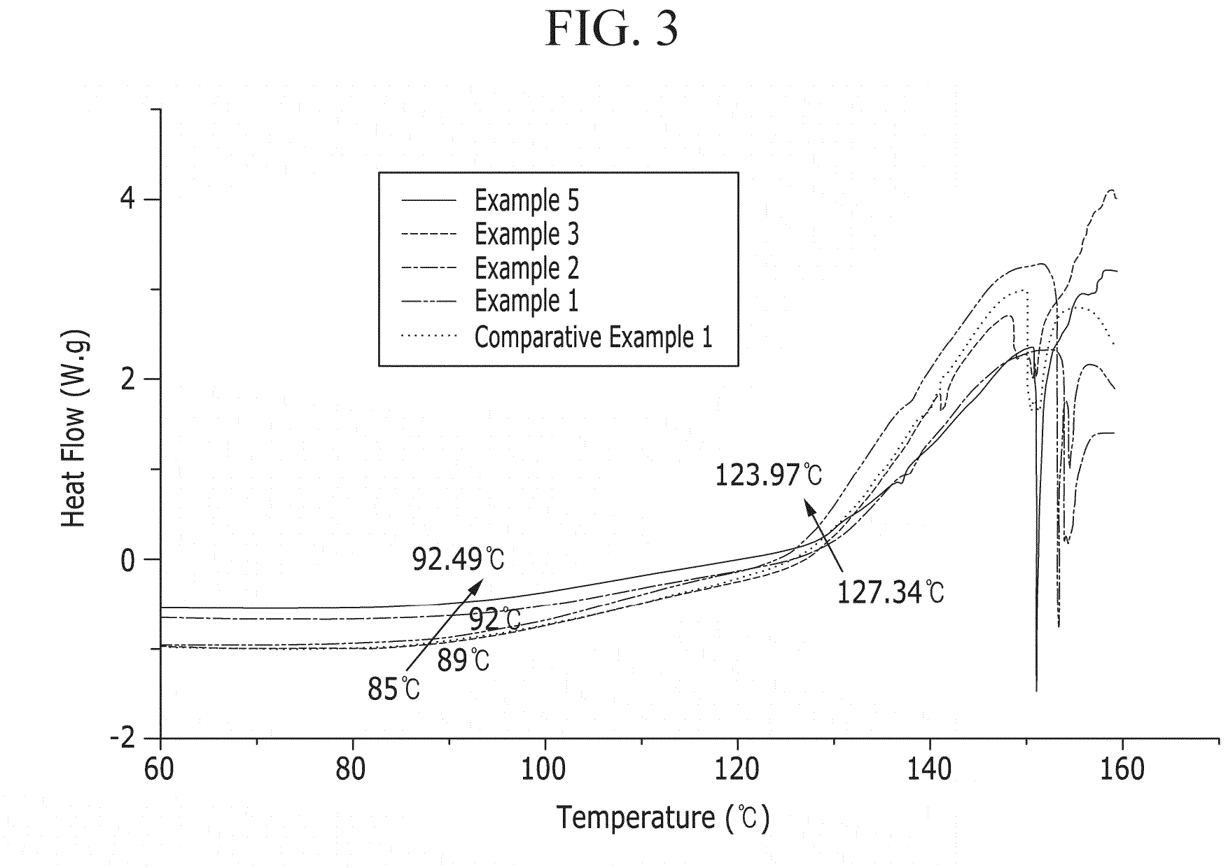

Subsequently, curing heat of the binder is measured. In order to measure curing heat of the binder, the binders are agitated, and casted on glass plates to be dried at room temperature, and then dried for 1 week or more under a reduced pressure to remove moisture remaining therein. After then, the measurement of curing heat due to cross-linking is performed by using differential scanning calorimetry (DSC), while heating the binders up to 160° C. at a rate of 2° C./min under a nitrogen atmosphere. The results are provided in the following Table 1 and FIG. 3.

TABLE 1

| | | Exothermic heat (W/g) | |
|---|---|---|---|
| | Weight (mg) of | (integral range: | Normalized heat |
| Binder | binder | 60° C.→off-set) | flow (W/g) |
| Comparative | 17.90 | 2.53 | 2.53 |
| Example 1 | | | |
| Example 1 | 16.59 | 2.18 | 2.11 |
| Example 2 | 13.01 | 2.37 | 2.23 |
| Example 3 | 17.92 | 2.63 | 2.44 |

As shown in Table 1 and FIG. 3, the binders including the latex according to Examples 1 to 3 become more exothermic due to curing during the heating, and show a higher temperature right after the curing than a counter group binder including no latex. However, as shown in FIG. 3, the exothermic heats due to curing of the examples reach a maximum of around 130° C., but they decrease at a temperature of greater than 120° C. compared with that of the counter group binder including no latex. The reason is that the binder including latex starts to be cured at a lower temperature and shows higher exothermic heat in the low temperature range, but shows lower exothermic heat than the binder including no latex at around 130° C. where the exothermic heat reaches a maximum or when the exothermic heats are averaged over the entire temperature range. In other words, the binder including latex shows lower curing heat. Further, a peak appearing at greater than or equal to 130° C. is an exothermic peak due to decomposition of the binder, and is not related to curing exothermic heat of the binder.

Accordingly, as shown in Table 1 and FIG. 3, a binder composition including latex may decrease the amount of curing heat of a binder and thus bring about an effect of decreasing energy during manufacture of an electrode.

### Examples 6 to 13 and Comparative Examples 2 and 3

### Manufacture of Anode for Capacitive Deionization Apparatus

Each anode for a capacitive deionization apparatus according to Examples 6 to 13 is manufactured by adding activated carbon and a conductive agent to the binder composition according to Examples 1 to 5 to prepare an electrode slurry and using the electrode slurry. Specifically, a method of manufacturing the electrode is illustrated as follows.

First of all, a polymer solution is prepared by adding 0.7 g of sulfosuccinic acid as a cross-linking agent and 2.8 g of sulfosalicylic acid as an ion exchange aid to 12.6 g of a PVA 10% aqueous solution and agitating the mixture. 0.45 g of Super-P as a conductive agent is added to the polymer solution, and the mixture is agitated with a Thinky mixer for 10 minutes. Activated carbon as an active material, PGW (Kuraray Chemical Co.) or SPY (Samsung Chuli Carbon) in an amount of 3 g is injected therein, and the resulting mixture is agitated with a Thinky mixer for 10 minutes. A 5% carboxylated SBR latex is added to each prepared slurry in the same amount as in Examples 1 to 5, and the mixture is agitated with a Thinky mixer for 5 minutes. When the slurry has too high a viscosity, water in an appropriate amount is additionally added to the reactant, and the mixture may be agitated.

The slurry is coated to be about 200 to 500 μm thick on one side of a conductive graphite sheet (thickness=250 μm) with a doctor blade, heat-treated in a hot air drier, and then dried and cured under the conditions in the following Table 2. The manufactured electrode is immersed in distilled water (DI water) for several hours to wash and remove a non-reaction cross-linking agent and an ion exchange group therefrom.

On the other hand, as described above, since the binder according to Comparative Example includes no latex, each anode according to Comparative Examples 2 and 3 is manufactured by using other electrode active materials in the same amount as described above except for adding no latex and respectively changing its curing condition.

TABLE 2

| | Latex content (PVA 10% | | Kinds of | |
|---|---|---|---|---|
| | solid content in an | | active | |
| Electrode | aqueous solution) | | material | Curing condition |
| Comparative | 0 | g | PGW | 120° C., 5 hours |
| Example 2 | | | | |
| Example 6 | 0.4 | g | PGW | 120° C., 5 hours |
| Example 7 | 0.8 | g | PGW | 120° C., 5 hours |
| Example 8 | 1.0 | g | PGW | 120° C., 5 hours |
| Example 9 | 3.0 | g | PGW | 120° C., 5 hours |
| Example 10 | 6.0 | g | PGW | 120° C., 5 hours |
| Comparative | 0 | g | PGW | 130° C., 40 minutes |
| Example 3 | | | | |
| Example 11 | 0.4 | g | PGW | 130° C., 40 minutes |
| Example 12 | 0.8 | g | PGW | 130° C., 40 minutes |
| Example 13 | 0.4 | g | SPY | 130° C., 40 minutes |

### Preparation Example 1

### Manufacture of Cathode for Capacitive Deionization Apparatus (CDI)

A cathode as a counter electrode for the anodes according to Examples 6 to 13 is manufactured in the following method.

(1) First, in order to prepare a binder, 2.1 g of glycidyl trimethylammonium chloride (GTMAC) is added to 12.6 g of a PVA 10% aqueous solution, and the mixture is agitated.

(2) 0.45 g of Super-P as a conductive agent and 3 g of activated carbon are added to the prepared polymer solution, and the mixture is agitated with a Thinky mixer for 10 minutes.

(3) 0.72 g of glutaric acid as a cross-linking agent is injected into the prepared slurry, and the mixture is agitated with a Thinky mixer for 10 minutes.

(4) The prepared slurry is coated to be 200 μm to 300 μm thick on one side of a conductive graphite sheet (thickness=250 μm) with a doctor blade.

(5) The coated sheet is dried at room temperature for 3 hours and heat-treated at 130° C. for 2 hours.

(6) The heat-treated sheet is dipped in distilled water (DI water) for several hours to wash and remove the non-reaction cross-linking agent and the ion exchange aid, manufacturing a cathode.

### Preparation Example 2

### Assembly of Capacitive Deionization Apparatus (CDI)

The anodes according to Examples 6 to 13 and the cathode according to Preparation Example 1 are used with a water-permeating open polyamide mesh as a spacer to manufacture a capacitive deionization (CDI) apparatus. The CDI apparatus is manufactured by sequentially laminating “graphite plate/anode/spacer/cathode/graphite plate” and fastening them together with screws.

### Experimental Example 1

### Evaluation of Ion Removal Performance of Capacitive Deionization (CDI) Apparatus

Ion adsorption removal experiments of the CDI apparatuses are performed according to the following procedure, and the results are respectively provided in Tables 3 to 7 and FIGS. 3 to 5.

(1) The CDI apparatus is operated at room temperature by providing 250 mg/L of a standard hard water solution (conductivity: −830 ρS/cm) at a rate of 27-28 mL/min.

(2) Each electrode is connected to electric power to maintain a cell voltage (a potential difference between anode and cathode) at 1.5 V for one minute for deionization, and then at −0.8 V for reproduction.

(3) Conductivity of water passed through the apparatus is measured in real time by using a flow-type conductivity sensor.

(4) The amount of electric charge in each step is measured from the amount of a current supplied through a power source.

(5) The measured ion conductivity is used to calculate an ion removal rate (%) of the apparatus according to the following formula.

Ion removal rate (%)=(conductivity of inflow water−conductivity of outflow water)/(conductivity of inflow water)*100

The standard hard water is used when it has ion conductivity of 83.0 mS by sufficiently dissolving 27.241 g of CaCl2.2H2O, 15.741 g of MgSO4.2H2O, and 27.887 g of NaHCO3 in 100 L of distilled water.

### (1) Performance Change Depending on Curing Temperature

Performance change depending on the curing temperatures of the CDI apparatuses respectively including the anodes according to the comparative example and the examples is measured and compared in the aforementioned method.

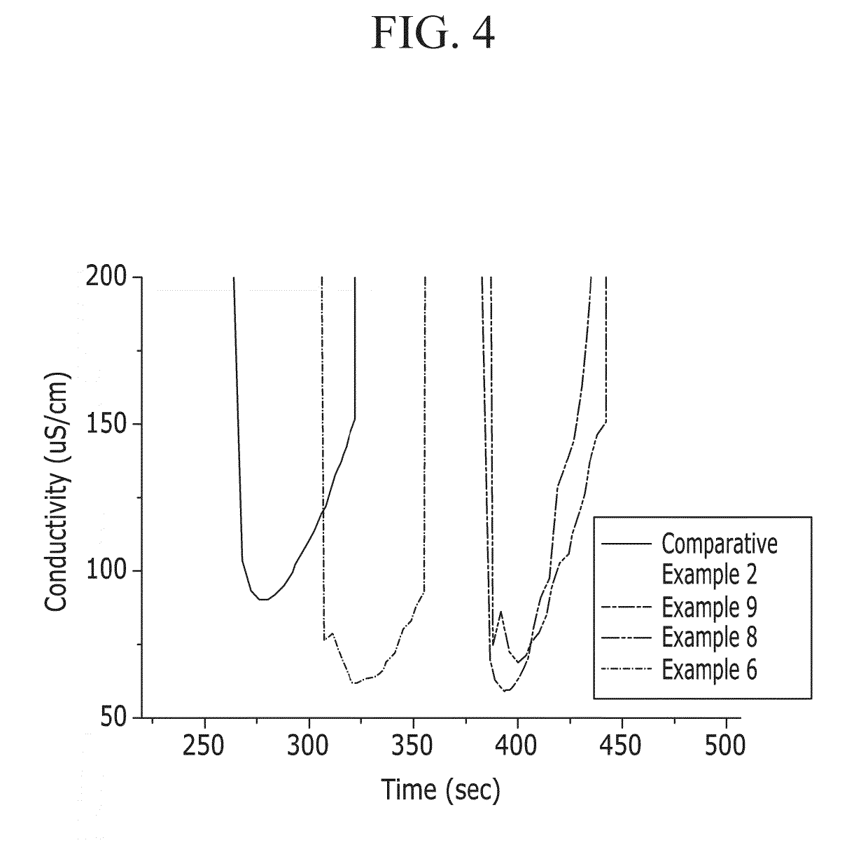

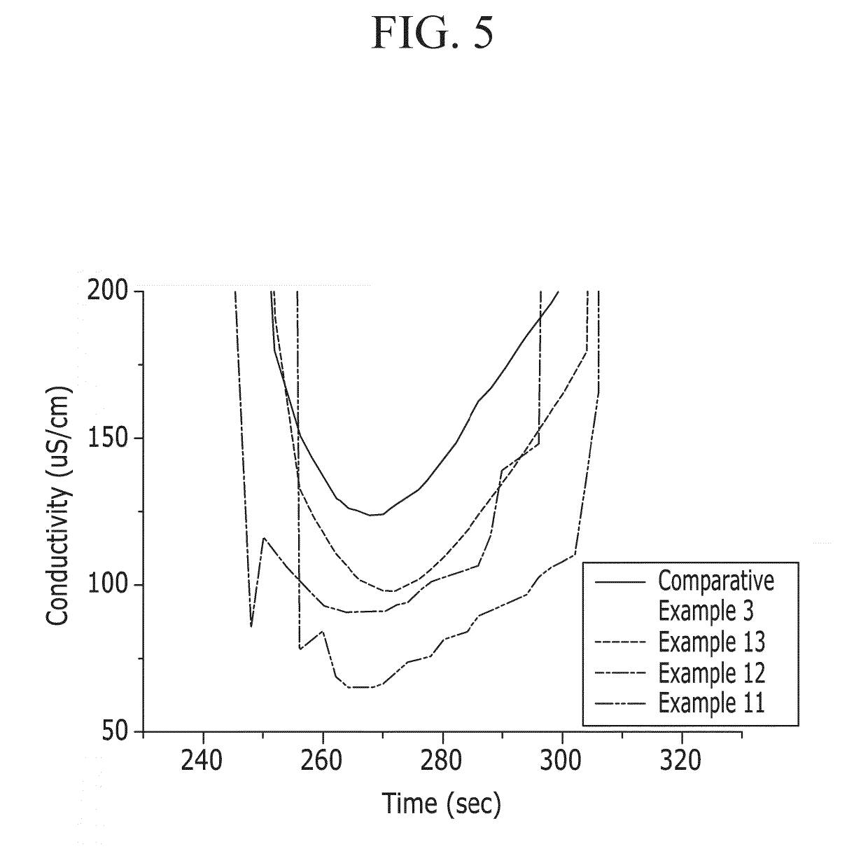

In other words, less than or equal to 100 μS/cm of ion conductivity maintenance time (sec) and minimum ion conductivity (μS/cm) of the CDI apparatuses using the anodes cured at 120° C. for 5 hours according to Comparative Example 2 and Examples 6, 8, and 9 are provided in the following Table 3 and FIG. 4, and less than or equal to 100 μS/cm of ion conductivity maintenance time (sec) and minimum ion conductivity (μS/cm) of the CDI apparatuses using the anodes cured at 130° C. for 40 minutes according to Comparative Example 3 and Examples 11 to 13 are provided in the following Table 4 and FIG. 5.

TABLE 3

| | Time (sec) | |
|---|---|---|
| | (Conductivity is less than or | Ion conductivity |
| Anode | equal to 100 μS/cm) | (μS/cm) |
| Comparative | 38 | 74.7 |
| Example 2 | | |
| Example 6 | 64 | 61 |
| Example 8 | 32 | 62.5 |
| Example 9 | 26 | 60.0 |

TABLE 4

| | Time (sec) | |
|---|---|---|
| | (Conductivity is less than or | Ion conductivity |
| Anode | equal to 100 μS/cm) | (μS/cm) |
| Comparative | 0 | 123 |
| Example 3 | | |
| Example 11 | 42 | 65 |
| Example 12 | 30 | 74 |
| Example 13 | 10 | 97 |

As shown in Tables 3 and 4, the CDI apparatus using the anode using a binder including latex according to the examples shows ion conductivity of less than or equal to 100 μS/cm for a longer time or lower ion conductivity, and thus a better ion removal rate than the CDI apparatus using the anode using a binder including no latex according to Comparative Example 2 or 3.

In addition, as shown from the comparison in Tables 3 and 4, the electrodes manufactured through curing for a longer time (5 hours) at a lower temperature (120° C.) according to Examples 6, 8, and 9 and through curing for a shorter time (40 minutes) at a higher temperature (130° C.) according to Examples 11 to 13 show similar improvement in ion removal efficiency despite different temperature and time for curing.

In other words, when a binder including a latex according to the present disclosure is used, the electrode may be manufactured at a lower temperature or in a shorter time, and thus with relatively small energy without decreasing ion removal performance of a CDI apparatus using the electrode including this binder.

### (2) Specific Resistance of Electrode

On the other hand, resistance of CDI apparatuses respectively including the electrodes according to the examples and comparative examples is measured and used to measure specific resistance of the electrodes at room temperature under a pressure of 2 metric tons/cm2 using a through plane method in order to examine whether the electrodes have higher resistance due to a binder including latex, and the results are provided in the following Tables 5 and 6. Specific resistance of the electrodes is calculated according to the following formula.

Specific resistance (mΩ)=[electrode resistance (mΩ)×electrode area cm²]/electrode thickness (μm)

TABLE 5

| | Thickness | Thickness | | | | | Electrode |
|---|---|---|---|---|---|---|---|
| | before | after | Electrode | | Electrode | Electrode | specific |
| | compression | compression | thickness | Resistance | resistance | area | resistance |
| | (μm) | (μm) | (μm) | (mΩ) | (mΩ) | (mΩ) | (mΩ) |
| Graphite | 250 | 160 | 160 | 2.3 | 2.3 | 3.36 | 483 |
| sheet | | | | | | | |
| Example 8 | 360 | 270 | 110 | 3.3 | 1.0 | 3.36 | 318 |
| Example 9 | 370 | 280 | 120 | 3.6 | 1.3 | 3.36 | 364 |
| Example 10 | 510 | 380 | 220 | 5.3 | 3.0 | 3.36 | 458 |

TABLE 6

| | Thickness | Thickness | | | | | Electrode |
|---|---|---|---|---|---|---|---|
| | before | after | Electrode | | Electrode | Electrode | specific |
| | compression | compression | thickness | Resistance | resistance | area | resistance |
| | (μm) | (μm) | (μm) | (mΩ) | (mΩ) | (mΩ) | (mΩ) |
| Graphite | 250 | 160 | 160 | 2.3 | 2.3 | 3.36 | 483 |
| sheet | | | | | | | |
| Comparative | 380 | 300 | 140 | 3.1 | 0.8 | 3.36 | 192 |
| Example 1 | | | | | | | |
| Example 11 | 390 | 280 | 120 | 3.3 | 1.0 | 3.36 | 280 |
| Example 12 | 390 | 310 | 150 | 3.6 | 1.3 | 3.36 | 291 |
| Example 13 | 380 | 300 | 140 | 2.9 | 0.6 | 3.36 | 144 |

As shown in Tables 5 and 6, the electrodes manufactured by using the binder including latex according to the present disclosure show lower specific resistance than a graphite sheet and a little higher specific resistance than the electrode manufactured by using the binder including only polymer PVA according to Comparative Example 1, but may maintain them at a low range sufficient to be used for a CDI apparatus.

While this disclosure has been described in connection with what is presently considered to be practical example embodiments, it is to be understood that the disclosure is not limited to the disclosed embodiments, but, on the contrary, is intended to cover various modifications and equivalent arrangements included within the spirit and scope of the appended claims.

1. A binder composition for an electrode of a capacitive deionization apparatus, the binder composition comprising:
a hydrophilic polymer;
a cross-linking agent;
an ion exchange group; and
a latex having an ionic functional group on a surface of the latex.

2. The binder composition of claim 1, wherein the hydrophilic polymer is at least one of polystyrene, polyacrylic acid, polyacrylic acid-co-maleic acid, polyvinyl alcohol, carboxylmethyl cellulose, hydroxypropyl cellulose, polyvinylchloride, carboxylated polyvinylchloride, polyvinylfluoride, polyvinylamine, chitosan, polyamide, polyurethane, polyacrylamide, polyacrylamide-co-acrylic acid, polystyrene-co-acrylic acid, polytetrafluoroethylene, polyvinylidene fluoride, polyethylene, polypropylene, polyvinylpyrrolidone, an epoxy resin, and a combination thereof.

3. The binder composition of claim 1, wherein the cross-linking agent is at least one of ethylene glycol, glycerol, 1,6-hexanediol, 1.4-butanediol, glutaric acid, glutaric aldehyde, succinic acid, succinic anhydride, adipic acid, phthalic acid, ethylene glycol diglycidyl ether, sulfosuccineic acid, sulfosalicylic acid, succinamic acid, ethylenediamine, and a combination thereof.

4. The binder composition of claim 1, wherein the ion exchange group is at least one of sulfoacetic acid, sulfophthalic acid, sulfosalicylic acid, hydroquinonesulfonic acid, sulfobenzoic acid, tetrabutylammonium hydroxide, tetrabutylammonium acetate, tetraethylammonium hydroxide, tetraethylammonium acetate, and a combination thereof.

5. The binder composition of claim 1, wherein
the latex is at least one of a latex of a butadiene-based hybrid polymer, a latex of a diene-based hybrid polymer, a latex of an acrylate-based hybrid polymer, a latex of a nitrile rubber, a latex of a chloroprene rubber, a polyurethane-based latex, an acrylic latex, and a combination thereof; and
the ionic functional group is one of a cation exchange group, an anion exchange group, and a hydrophilic group.

6. The binder composition of claim 5, wherein
the cation exchange group is one of a carboxyl group, a sulfonic acid group, a hydroxy group, a phosphinic group, an arsonic group, a selenonic group, or a combination thereof, and the anion exchange group is an amine group selected from a primary amine (—NH₂), a secondary amine (—NHR), a tertiary amine (—NR₂), a quaternary ammonium salt (—NR₃), a quaternary phosphonium group (—PR₄), a tertiary sulfonium group (—SR₃), and a combination thereof, and
the hydrophilic group is an epoxy compound.

7. The binder composition of claim 5, wherein the latex is one of a SBR (styrene butadiene rubber) latex, a NBR (nitrile butadiene rubber) latex, a latex of PMMA (polymethylmethacrylate) and a copolymer thereof, a latex of polystyrene and a copolymer thereof, an ethylene vinyl acetate (EVA) latex, an acrylic latex, and a combination thereof.

8. The binder composition of claim 1, further comprising:
a solvent including water.

9. The binder composition of claim 1, wherein
the cross-linking agent is included in an amount of about 5 to about 100 parts by weight based on 100 parts by weight of the hydrophilic polymer; and
the ion exchange group is included in an amount of about 10 to about 300 parts by weight based on 100 parts by weight of the hydrophilic polymer.

10. The binder composition of claim 1, wherein the latex is included in an amount of about 10 to about 400 parts by weight based on 100 parts by weight of the hydrophilic polymer.

11. An electrode composition for a capacitive deionization apparatus, the electrode composition comprising:
the binder composition of claim 1; and
an electrode active material.

12. The electrode composition of claim 11, wherein the electrode active material is one of an activated carbon powder, an activated carbon fiber, carbon nanotubes, a carbon aerogel, mesoporous carbon, a graphite oxide, and a mixture thereof.

13. The electrode composition of claim 11, wherein the electrode active material is included in an amount of about 5 to about 400 parts by weight based on 100 parts by weight of the hydrophilic polymer in the binder.

14. The electrode composition of claim 11, further comprising:
at least one conductive material, the conductive material including one of VGCF (vapor growth carbon fiber), natural graphite, artificial graphite, acetylene black, ketjen black, XCF (electrically conductive furnace) carbon, SRF (semi-reinforcing furnace black) carbon, a carbon fiber, copper, nickel, aluminum, silver, a conductive polymer, LiCl, NaCl, KCl, and a mixture thereof.

15. The electrode composition of claim 14, wherein the conductive material is included in an amount of about 0.1 to about 35 parts by weight based on 100 parts by weight of the electrode active material.

16. An electrode for a capacitive deionization apparatus comprising the electrode composition of claim 11.

17. The electrode of claim 16, wherein the electrode is an anode.

18. A capacitive deionization apparatus comprising:
a first electrode;
a second electrode facing the first electrode; and
a spacer between the first and second electrodes,
wherein at least one of the first and second electrodes includes the electrode composition of claim 11.

19. The capacitive deionization apparatus of claim 18, further comprising:
a charge barrier between the spacer and at least one of the first electrode and the second electrode, the charge barrier including a material different from the electrode active material.

20. A method of removing ions from a fluid, the method comprising:
simultaneously supplying an ion-containing fluid to the capacitive deionization apparatus of claim 18, and applying a voltage to the first and second electrodes of the capacitive deionization apparatus.
